(19) United States
(12) Patent Application Publication
(10) Pub. No.: US 2014/0167326 A1
(43) Pub. Date: Jun. 19, 2014

(54) ADDITIVE BUILDING

(71) Applicants: Jason Blair Jones, Coventry (GB); Gregory John Gibbons, Coventry (GB)

(72) Inventors: Jason Blair Jones, Coventry (GB); Gregory John Gibbons, Coventry (GB)

(73) Assignee: University of Warwick, Coventry (GB)

(21) Appl. No.: 14/122,913

(22) PCT Filed: May 31, 2012
(86) PCT No.: PCT/EP2012/060241

§ 371 Date: Feb. 10, 2014

(30) Foreign Application Priority Data
May 31, 2011 (GB) 1109045.3

(51) Int. Cl. B29C 67/00

(52) U.S. Cl. CPC B29C 67/0081
USPC 264/427; 264/447; 425/162

(57) ABSTRACT

An additive building method for building a plurality of layers to form a build stack is provided. The method includes creating a variable potential difference between a conducting element at a first voltage potential and an ion source at a second voltage potential, and creating an electric field between the conducting element and the ion source. The electric field passes through the build stack to a nearest surface of the build stack which is nearest a transfer medium. The method further includes accumulating electric charge from the ion source on the nearest surface of the build stack, and transferring deposition material from a transfer medium onto the nearest surface. The strength of the field at the nearest surface of the build stack is controlled in order to cause a homogenous transfer of the deposition material on to the nearest surface.

### FIELD

The present invention relates to additive building and in particular relates to improvements in three dimensional (3D) print technologies.

### BACKGROUND

3D printing, also known as additive manufacturing is a manufacturing technology in which a three dimensional object is created by printing or laying down successive layers of a material. 3D printers offer a fast way to create prototype objects. A 3D printer works by converting a 3D computer model of the object and creating a series of cross-sectional slices. Each slice is then printed, one on top of the other, to create the 3D object.

The overwhelming majority of 3D printing techniques are not capable of depositing multiple materials in a single part. Currently the only systems capable of simultaneously depositing multi-material parts are based on extrusion and inkjet printing systems. In one such inkjet printing system, the printer creates the model one layer at a time by depositing several UV curable inks in the shape of the cross-section of the part which is cured by a UV source. The process is repeated until every layer is printed.

One disadvantages associated with using inkjet printing systems for 3D printing is that it is a ‘wet’ printing technique and requires that the medium to be “printed” is either a liquid or can be suspended in a liquid. However, this has limitations for the materials which can be used in this manufacturing technique as not all substances are able to be suspended in a liquid.

Another disadvantage relates to the limited resolution of printed images using existing techniques. Droplet stability in inkjet limits most functional ink applications to a native resolution of 600 DPI (˜42 μm resolution).

Furthermore, the intended result of additive manufacture is a solid (or semi-solid) body. As discussed above all inkjet deposition technology requires a liquid carrier. The major component of each droplet dispensed from an inkjet head is the liquid carrier which usually accounts for 60% or more of the drops' volume. Therefore, when using inkjet technology it is necessary to deposit a total volume of media far in excess of the volume needed in order to accumulate the required volume of solid material. Typically, the total volume may be twice the required volume of solid material. In addition, as described in U.S. Pat. No. 7,322,688, the carrier should fall within a specific viscosity range at the print temperature: a typical range is 5 to 45 centipoise. This means an additional control overhead in order to operate this printing technique correctly.

Furthermore, the liquid carrier must be removed or converted to a solid which has significant implications on the time required to print and solidify each layer. In general, print (and some Additive Manufacturing systems such as ZCorp™ and Voxeljet™) applications after droplets are printed, it is necessary to wait for the aqueous portion of the droplet to evaporate or be absorbed/react with the substrate.

Heated inkjet heads can print liquid wax. However, it is necessary to wait for the wax to solidify (phase change) before being able to deposit another layer on top. This system is used in Solidscape™ Additive Manufacturing systems. While solidification or phase change can be achieved by including photo initiators in the ink, which are then UV cured to cause cross-linking of the polymer, there is still a time delay before new layers can be printed or deposited

A further disadvantage relates to the scalability of existing printing techniques for additive manufacturing. Inkjet technology relies upon micro-scale deposition nozzles which are normally arranged in an array. It is not generally cost-effective to produce an array (or even sets of arrays) which span the entire width of print and so the print head is moved back and forth in order to cover the entire width. This also has an impact on the speed of the print technique.

In addition, the micro-scale nozzles in an inkjet head have the propensity to clog. This problem is exacerbated especially if the printer is used intermittently; or when the print material (ink) has a chemical make-up which is susceptible to cross-linking over time.

By way of background, electrophotography is usually a dry printing technique which uses a toner and a light sensitive surface, which is often on a roller or drum, to transfer the printed image on to the desired medium: e.g. paper in laser printers or photocopiers.

The surface of the drum or roller is light sensitive and may be referred to as a photoreceptor or photoconductor. The surface may be coated using an inorganic or organic photosensitive material. Due to the widespread use of organic photoconductors, this drum is often referred to as an (OPC). The drum rotates in order to transfer the printed image through one or more revolutions, during which the drum surface passes through the steps described below:

Step 1. Charging

An electrostatic charge is uniformly distributed over the surface of the drum by a corona discharge from a Corona wire. This effect can also be achieved with the use of a contact roller with a charge applied to it. The polarity of the charge applied to the surface may be chosen to be positive or negative depending on the polarity of the toner which is to be used.

Step 2. Exposure

In a laser or LED printer, modulated light is projected onto the drum surface to create a ‘latent’ image. Where the drum is illuminated the charge is caused to dissipate. The charge pattern that remains on the drum after this exposure is the latent image.

Step 3. Development

The drum is presented with a mixture of toner particles and larger, metallic, carrier particles. The carrier particles have a coating which, during agitation, generates a form of static electricity, which attracts a coating of toner particles onto the surface of the drum. The mix is manipulated with a magnetic roller to present to the surface of the drum/belt a brush of toner. By contact with the carrier each neutral toner particle has an electric charge of polarity opposite to the charge of the latent image on the drum. The charge attracts toner to form a visible image on the drum. To control the amount of toner transferred, a bias voltage is applied to the developer roller to counteract the attraction between toner and latent image. In the description above, a two component developer system has been described. However, a person skilled in the art will appreciate that a mono component developer could also be used.

Step 4. Transfer

Paper is passed between the drum and a transfer corona, which has a polarity that is the opposite of the charge on the toner. The toner image is transferred by a combination of pressure and the resulting electrostatic attraction, from the drum to the paper.

Step 5. Separation or Detack

Electric charges on the paper are neutralized after the transfer corona. As a result, the paper, complete with most (but not all) of the toner image is separated from the drum.

Step 6. Fixing or Fusing

The toner image is permanently fixed to the paper using either a heat and pressure mechanism (Hot Roll Fuser) or a radiant fusing technology (Oven Fuser) to melt and bond the toner particles into the paper.

Step 7. Cleaning

The drum, having already been partially discharged during detack, is further discharged, by light, and any remaining toner, that did not transfer in Step 6, is removed from the drum surface by a rotating brush.

These principles of electrophotography are well understood in the art. The benefits of using electrophotography are that it is cheaper for each page printed, there is the possibility of achieving better resolutions up to 2400 dpi, and the printing time is faster and the technique is capable of printing hundreds of pages per minute.

Regardless of the above described advantages of electrophotography, this printing technique has not previously been used in 3D printing for direct deposition of material for additive manufacturing before because the existing electrophotography technique cannot ensure the print quality as the number of layers increases.

The reason for the degradation in the print surface is that there is an accumulation of charge, with each layer printed. The cause of this charge accumulation is twofold: 1) the deposited toner particles themselves still carry a significant charge (even though they have been discharged slightly during detack and as a result of a natural charge decay over time), and 2) where a charged final transfer roller is used the substrate and previously printed toner layers are being contact charged, i.e. charge is conducted from the transfer roller to the substrate/previous layer when they come into contact with each other. This means that new toner particles are not transferred uniformly onto the previously deposited layers because they are being repelled in proportion to the same sign charge accumulation on the previously printed surface. Traditionally, this problem has ensured that electrophotography has only been suitable for printing a limited number of layers, for example up to eight layers. Furthermore, the surface quality degrades to a sufficient degree to prevent the printing of multiple layers or 3D objects.

### SUMMARY

The invention provides an additive building method for building a plurality of layers to form a build stack, comprising: providing a transfer medium with electrically charged particles to be deposited in successive overlying layers to provide the build stack, depositing one of the layers of charged particles onto a substrate to provide a first layer, reducing a repulsive effect of residual charge of the first layer for a second of the layers subsequently deposited on the first layer, and depositing the second of the layers of charged particles from the transfer medium onto the first layer, the reduction of the repulsive effect being performed such as to prevent an accumulation of residual charge resulting from the successively deposited layers and to provide homogeneous deposition of the layers.

The first layer may be the initially deposited layer of the build stack or may comprise an intermediate layer of the stack.

The repulsive effect of residual charge on the deposited layers may be at least partially reduced by applying an electric field and the disposition of the field may be adjusted to maintain the reduction of the repulsive effect for the successively deposited layers.

The disposition of the field may be adjusted by applying a potential difference to create the electric field and increasing the potential difference in dependence the number and/or thickness of the layers deposited. A conductive layer may be introduced between the first and second of said layers.

The repulsive effect of the residual charge may also be reduced or overcome by discharging the first of the layers prior to deposition of the second of the layers. This may include discharging the upper surface of the first of the layers by applying a conductive coating.

Also, the method may include discharging the first of the layers by applying a further layer of charged particles of opposite polarity to that of the residual charge.

The reducing of the repulsive effect of residual charge on the first deposited layer facilitates an improved quality of successive layer deposition.

The invention also includes a system for performance of the deposition method.

One embodiment of the present invention uses a conductive plane, for example a copper or aluminium sheet in order to create a potential difference between a transfer medium and the surface to be printed on. Alternatively, the plane may be provided as a conductive polymer and in a preferred embodiment the plane may be provided as a semiconductor material. In this embodiment, the semiconductor material operates to become selectively charged. The conductive plane in another embodiment may be replaced with a conductive element like a corona wire. In all cases, the conductive plane or element has the advantage of causing the charged surface to become homogenised. This, in turn, improves the surface quality of the printed layer.

### BRIEF DESCRIPTION OF THE DRAWINGS

Embodiments of the present invention will now be described by way of example with reference to the accompanying drawings, in which:

FIG. 1 is a schematic illustration of an additive building method in accordance with the invention;

FIG. 2 is a schematic diagram of one embodiment of the present invention;

FIG. 3 is a flowchart of the method steps for the embodiment of the present invention shown in FIG. 2;

FIGS. 4a to 4d are schematic diagrams of the transfer means of one embodiment of the present invention illustrating how the residual charge can be compensated with increasing thickness and increasing numbers of deposited layers;

FIGS. 5a, 5b and 6 are illustrations of a ‘leap-frogging’ embodiment of the present invention;

FIG. 7a is an illustration of a transfer arrangement generally as shown in FIG. 1;

FIG. 7b is an illustration of a capacitive transfer embodiment of the present invention; and

FIG. 8 is an illustration of a comparison between the transfer arrangement of FIG. 7a and the capacitive transfer of FIG. 7b.

### DETAILED DESCRIPTION

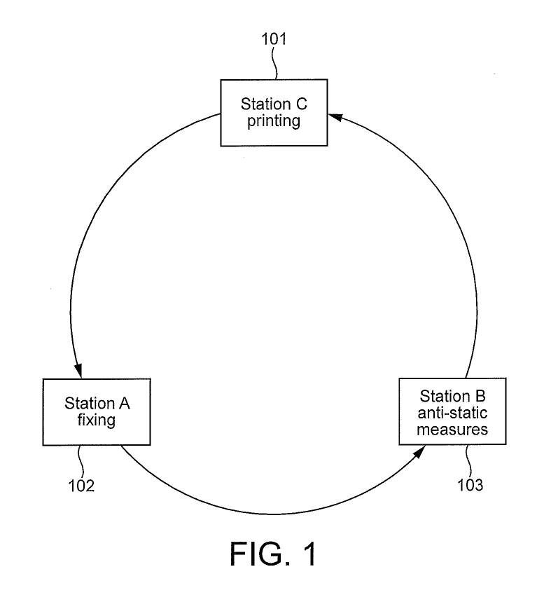

FIG. 1 shows an arrangement according to one embodiment of the present invention for additively building 3D structures. The embodiment represented in FIG. 1 comprises a plurality of processes including a deposition process 101 to deposit the overlying layers of electrostatically charged particles e.g. toner particles deposited in layers by a electro-lithographic printing process, a fixing process 102 for the individual deposited layers and a process 103 to remove accumulated charge from deposited layers, referred to herein as anti-static measures, before the next of the layers in the resulting stack is deposited. In the general example shown in FIG. 1, individual layers of the 3D structure are defined in shape by a laser printing process and deposited by an electrostatic transfer process from a transfer drum onto a substrate at station C, after which the deposited layer is fixed at station A. Thereafter the substrate moves to station B where anti-static measures are performed to remove residual charge from the surface of the deposited layer that would otherwise act to repel charged particles to deposited in the next layer at station C, thereby resulting in homogeneous layers being deposited successively.

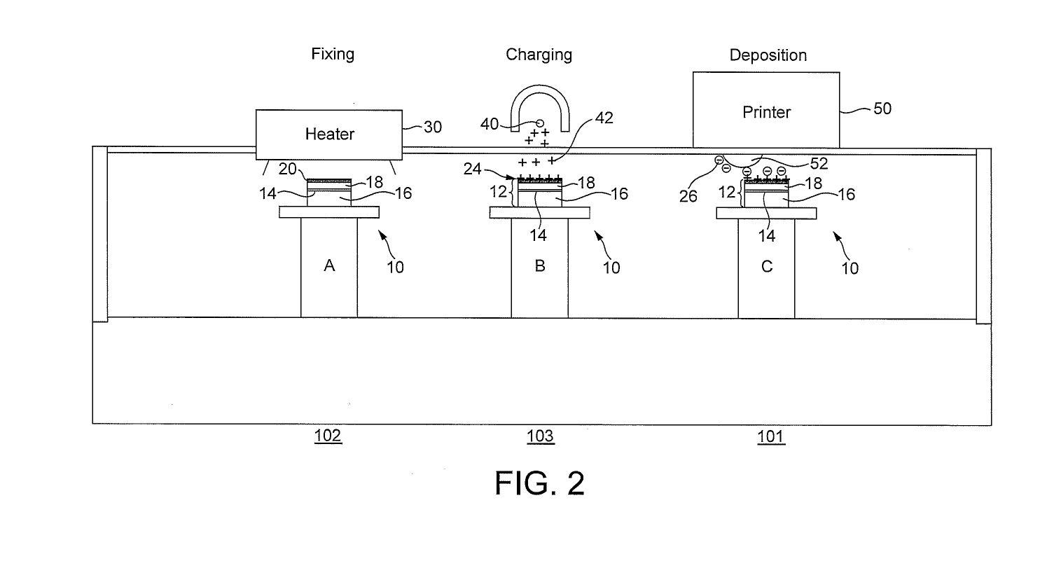

An example of a printing arrangement according to the principles of FIG. 1 is shown in more detail in FIG. 2. A build platform 10 is caused to travel between the stations, A, B, C. In one embodiment, the build platform 10 may be situated on a conveyer belt (not shown), but other arrangements could be envisaged by the skilled person. For example, the build platform 10 may be fixed in a location, and the stations A, B, C may be caused to travel to the build platform's location. Additionally, multiple build platforms could shuttle through the stations. In this example, an electrostatic field is utilised to reduce a repulsive effect of residual charge on the surface of a deposited layer on charged particles for the next layer subsequently deposited on the first layer.

The build platform 10 comprises a base plate 12 onto which a printed body is built as a plurality of overlying, printed layers. As shown, the base plate 12 comprises a conductive plate 14 situated on a first insulating layer 16. A second insulating layer 18 is formed above the conductive plate 14. A plurality of print layers 20 are successively deposited or printed onto the base plate or last print layer.

Station A at which the fixing process is carried out after a print layer has been deposited at Station C, comprises a heater 30 in this example and may operate as described at step 6 described above.

In this example Station B includes a high voltage corona wire 40 for an ion transfer (charging) process described below as an anti-static measure in preparation for the next printed layer.

Station C is a printer 50 for the deposition process. The printer 50 is an electro-reprographic printer which includes a print drum on which electrostatic latent images are formed successively for each successive layer of the 3D object to be printed. Each latent image is developed with negatively charged toner particles and provided on a transfer roller 52 so that it can be transferred onto the plate 12. Each layer can be dimensioned accurately in accordance with conventional electro-reprographic techniques e.g. using a laser to expose the drum to create the latent image.

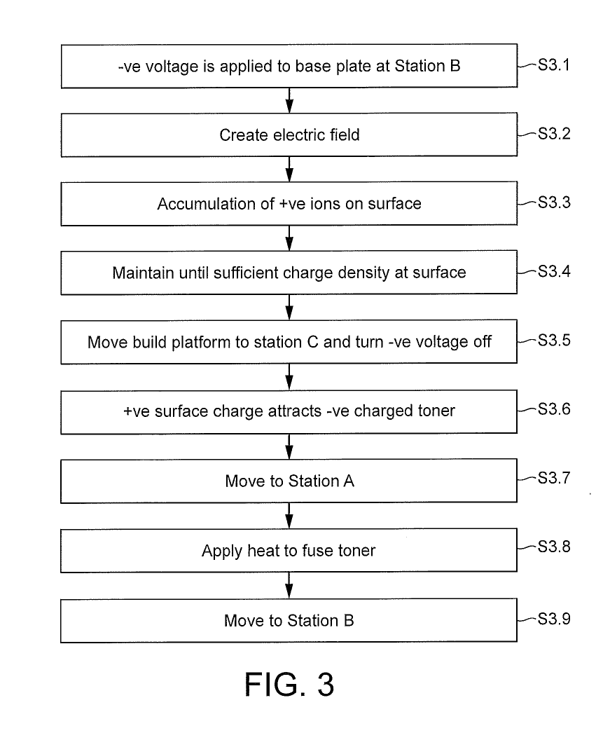

The embodiment shown in FIG. 2 is referred to as a field assisted ion transfer embodiment, and is described with reference to the flowchart of FIG. 3. For the purposes of the following description, reference is made to a toner 26 having a negative charge. A person skilled in the art will appreciate that this is not essential and that the process can be easily adapted and is therefore also applicable to toner having a positive charge.

At or around station B, the conductive plate 14 is charged with a negative voltage at step S3.1. This creates an electric field due to the potential difference between the high voltage corona wire and the plate (at step S3.2).

The field attracts positive ions 42 (or cations) which assist or accelerate the accumulation of positive charge on a top surface 24 of a printed body 20 (step S3.3). The surface may be the second insulating layer 18 of the base plate 12 in the case of a first layer being printed, or may be a previous print layer 20.

As discussed hereinbefore, when multiple layers of toner are printed by an electro lithographic process on top of one another, the surface quality is degraded as the number of layers increases due to a build up of residual charge on the surface, which inhibits the uniform transfer of the next layer of charged toner particles from the transfer roller 52 of the printer. Such unwanted residual negative charge that would otherwise build up on the top surface 24, is removed at Station B by forming a uniform positive surface charge on the surface 24 (step S3.4), which also assists the transfer of the next toner layer in the printing process at station C, described below.

The charging state is maintained for a sufficient time period at station B in order to accumulate sufficient charge density on the surface to cancel residual negative charge on the top surface 24 and also to accumulate an evenly distributed positive surface charge to assist in the printing process at station C. In one embodiment, this is accomplished by driving the build platform 10 slowly underneath the high voltage corona wire 40. The time period for passing the build platform 10 under the corona wire 40 may be in the range of 0.1 to 60 seconds (depending on the ion density produced by the ion source and the strength of the field attracting those ions). In an alternative embodiment, the build platform 10 is arranged to stop and dwell underneath the wire 40 for a set duration, for example 0.1 to 60 seconds. The time frames given are an indication only and do not represent any limitation on the timings used.

At the end of the above allocated time period, when there is a sufficient accumulation of positive charge, the build platform moves to station C. Before arriving at station C, the negative voltage supplied to the conductive plate 14 is turned off (at step S3.5). This is because if the voltage is not switched off an undesirable field between the base plate 12 and a transfer roller 52 within the printer 50 would be induced. This field would undesirably act to repel the toner 26 from the printed body 20, rather than attract it.

When the build platform 10 is in station C, the positive charge on the surface of the printed body attracts the negatively charged toner 26 from of the transfer roller 52, onto the upper surface 24 of the printed body 20 as shown at step S3.6.

In one embodiment, this attraction is assisted by the application of pressure from the roller 52 onto the surface 24 of the printed body 20. In addition, in the case where there is already at least one printed layer 20 in the body, the previously printed layer 20 may still be hot. In this case, the last printed layer has a sticky nature which also assists in the attraction and retention of toner 26 on to the last printed layer. The toner 26 remains electrostatically trapped in place while the build platform 10 travels to station A (step S3.7).

After the printing at station C, the platform is moved to Station A where the freshly deposited toner 26 is fused or fixed in place. The fusion is effected using the heater 30 (step S3.8).

In another embodiment, the toner may be fused in place through application of a chemical agent or binder after deposition of each layer. Alternatively, in another embodiment a spring adhesive may be used.

After the fixing of the last printed layer at station A, the build platform 10 can return to station B (step S3.9) to be charged again by the corona wire such that another print later can be deposited in station C.

A person skilled in the art will appreciate that the ion source shown as a separate process in FIG. 2 does not need to be independent of the printer or deposition process at station C. The key requirement is in generating a potential difference between the ion source 40 and the conductive plane/element 14. This potential difference in turn controls the strength of the electric field and so can ensure the homogenous transfer of deposition material or toner onto the surface 24 of the printed body.

While the above description relates to printing and printers, it is to be appreciated that the described techniques could be used for any process which uses charged powders such as brush (EMB) coating techniques, powder coating, etc.

As described above, the ion source or corona wire 40 is used to charge the surface of the printed body. In order to ensure a sufficient charge on the upper surface 24, the conductive plate 14 is connected electrically to a very high voltage source, for example, above 1000 volts DC. At such high voltages and at even higher voltages for example, 3000 volts DC, the surface quality is sufficiently improved such that the average roughness is 1 μm Ra.

The voltage applied to the conductive plate is variable and is controlled as part of the print process. In effect the voltage is controlled in order to control the strength of the field at the upper surface 24 of the printed body 20. The voltage is controlled in order to achieve optimum field strength on the upper surface 24 for counteracting the residual charge that occurs after each successive layer is printed, notwithstanding the successive increase in numbers of layers printed.

By actively controlling the voltage of the conductive plate, and as such the field strength, it is possible to print multi-layer bodies with tribocharged (charged by friction) toner or powder particles. As layers are successively printed, and as the depth of the printed body 20 increases, the voltage applied to the plate is incremented in order to maintain the field strength on the upper surface 24. On one embodiment, the voltage is incremented after each layer is printed such that the optimum field strength (also referred to as critical field strength) is maintained for the transfer and detack steps performed at station C when the next successive print layer is applied. The voltage is thus progressively increased in order to offset any shielding or polarization effects caused by the accumulation of new toner or print layers.

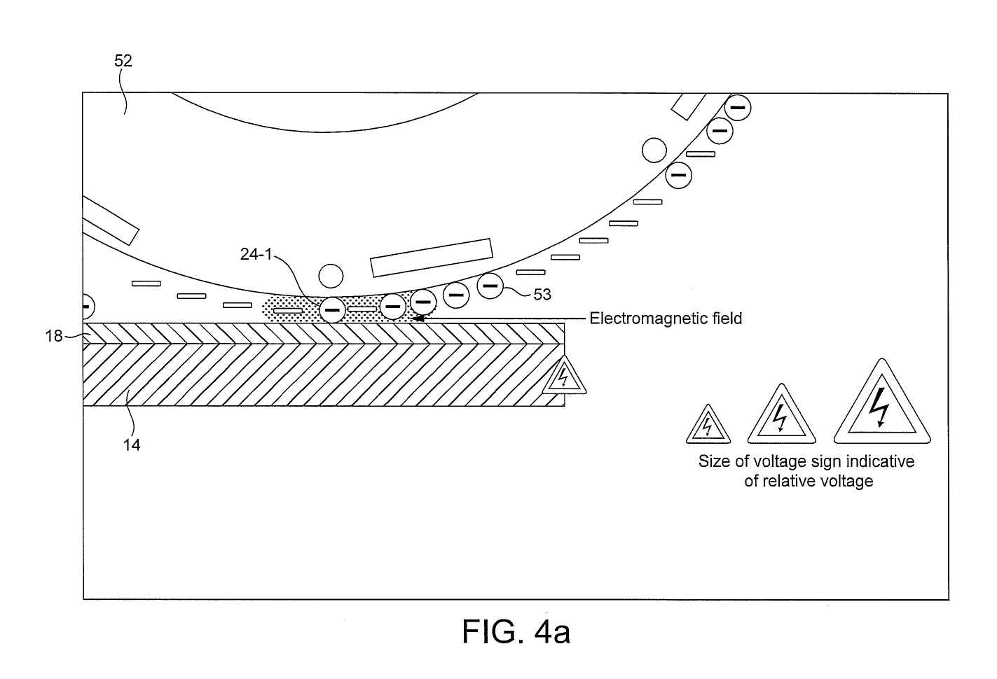

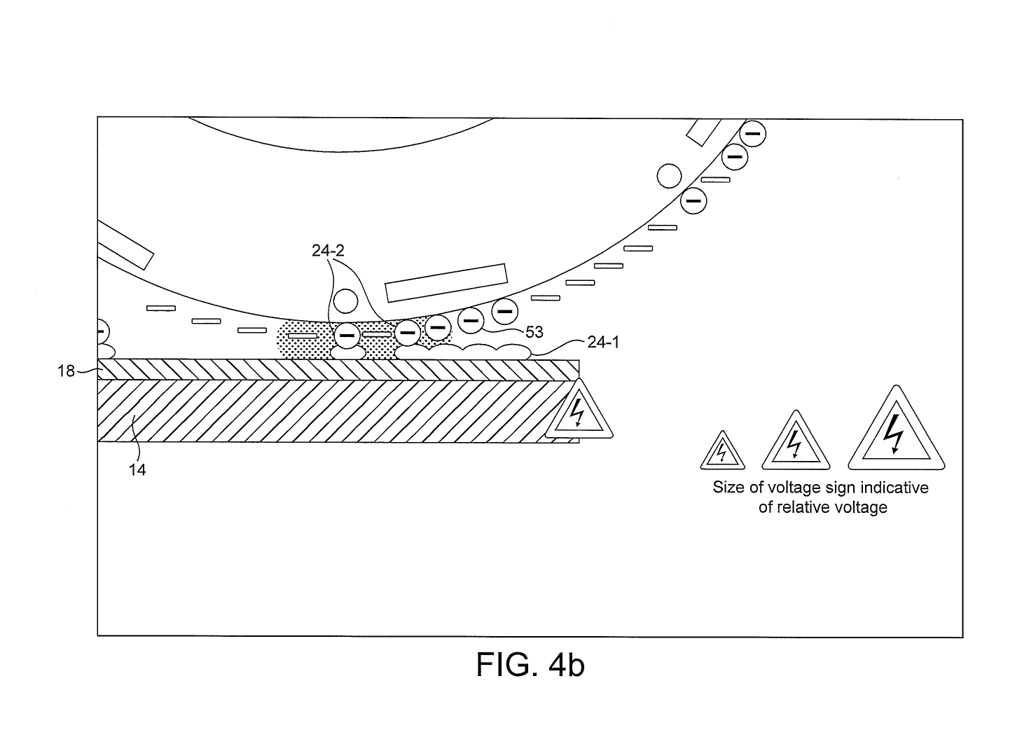

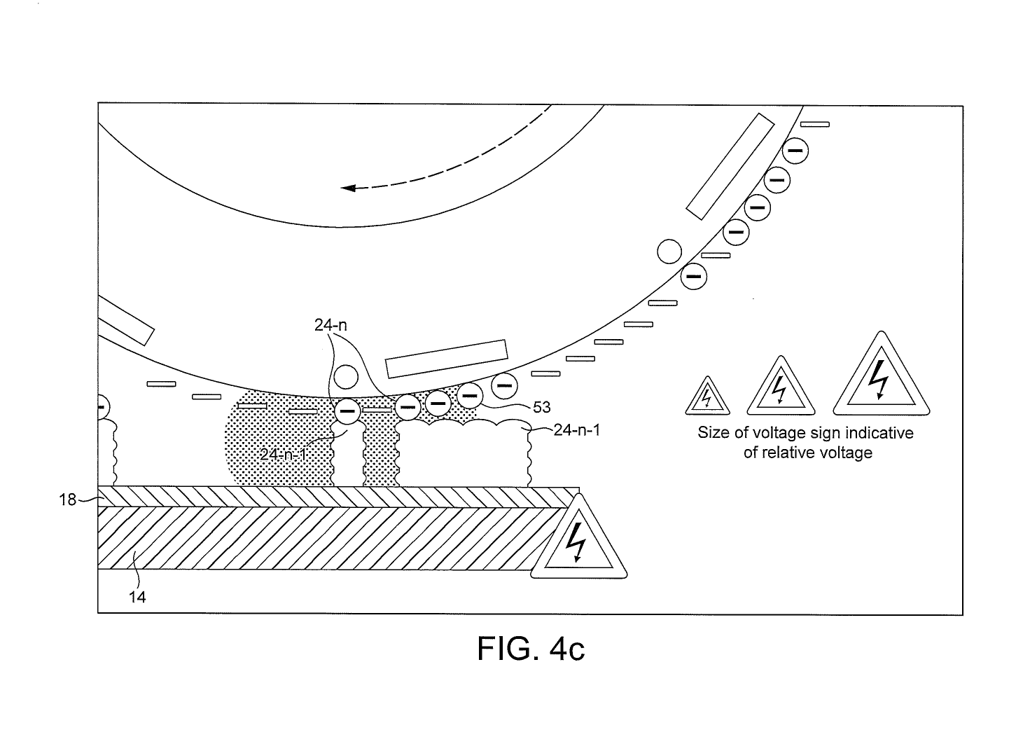

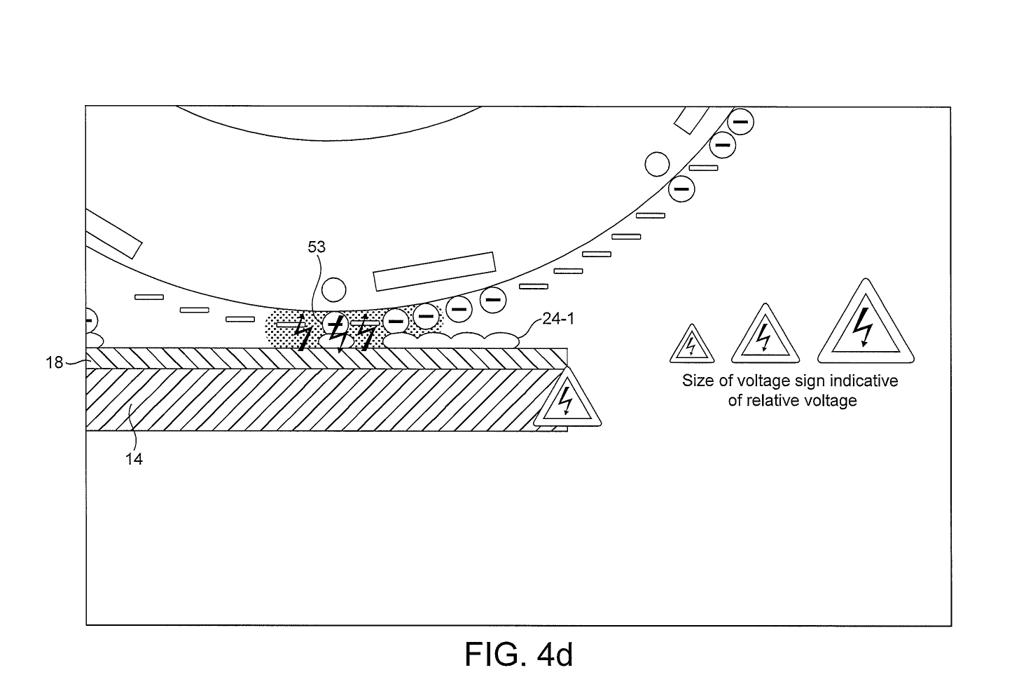

FIGS. 4a to 4c show the transfer or deposition process of station C in FIG. 1 in more detail.

FIG. 4a shows the drum or transfer roller 52 at station C with a spatial array of negatively charged toner particles 53 that have developed an electrostatic latent image 54 previously recorded on the drum e.g. by conventional techniques described above using a laser (not shown). The toner particles 53 are shown in the process of being transferred as the first layer of toner 24-1 onto the second insulating layer 18. In the immediately preceding charging step at Station B, a relatively low negative voltage was applied to the base plate 12.

FIG. 4b shows a second layer 24-2 of toner being transferred from a second, toner developed latent image on the drum 52. In the immediately preceding charging step at station B, an increased negative voltage was applied to the base plate 12. The increased voltage is required to enable the field to pass through the first layer 24-1 of toner and achieve a suitable level of uniform positive surface charge to attract the next layer 24-2 deposited as shown in FIG. 4b.

FIG. 4c shows a nth layer of toner being transferred. The voltage needs to be increased yet again beforehand at station C in order to ensure that the field passes through all of the previous layers of toner to create a suitable level of positive surface charge before the next print layer 24 is deposited at station C.

The size of the applied voltage is shown schematically with respect to the size of triangular High Voltage signs. It is to be appreciated that the voltage is not being applied during the transfer or deposition process because as described above, this s would cause the toner to be repelled from the build platform. The voltage symbols are included to give reference to the level of the voltage which was applied during the charging process at station B.

FIG. 4d shows what would happen if there was no active control of the voltage used to generate the field required for transfer. If a fixed voltage of a sufficient magnitude to ensure that the electric field permeates through a plurality of printed layers as desired, sparking would occur during the printing of the initial layers. This is because the voltage is too high, and the insulation provided by the second insulating layer and the plurality of printed layers is insufficient. In addition, regardless of the sparking problem, insufficient field strength on the upper surface of the printed body would result in poor surface quality as more layers were added.

The conductive plate 14 in one embodiment is made from aluminium. However the plate can be made of any suitable conductive metal or polymer or semiconductor material.

In one example, a standard black polyester toner, Samsung Poly-JZ™ was deposited according to the described procedure to a thickness of 1 mm with minimal surface irregularities.

Furthermore, it is possible to create 3D parts of higher thickness, for example 100 mm or more.

In order to build 3D parts of such greater thicknesses it is necessary to print layer upon layer in order to build up the material to form the 3D object. When the conducting plate 14 is charged at a given voltage, in order to achieve the critical field strength, there is a limit to the depth through the built-up material that the field permeates to achieve the desired outcome.

Although it is theoretically possible to establish a field through any thickness of material provided there is a large enough potential difference, there comes a point where it is no longer practical or safe to do so. Furthermore, there comes a point where the printed surface is no longer homogenous (depending on the variability in composition, density, and temperature of the deposited material). This imposes a limitation to the depth of material which can be built using this technique.

In order to overcome this limitation, the inventors have devised a technique whereby the field is caused to permeate further through the material without the need to increase the voltage applied to plate 14 to an unacceptably high level so that more and more layers can be built up. The technique is referred to herein as leap-frogging and involves minimising the change in distance between the top of the progressively building stack of printed layers and the potential established on the conductive plate 14.

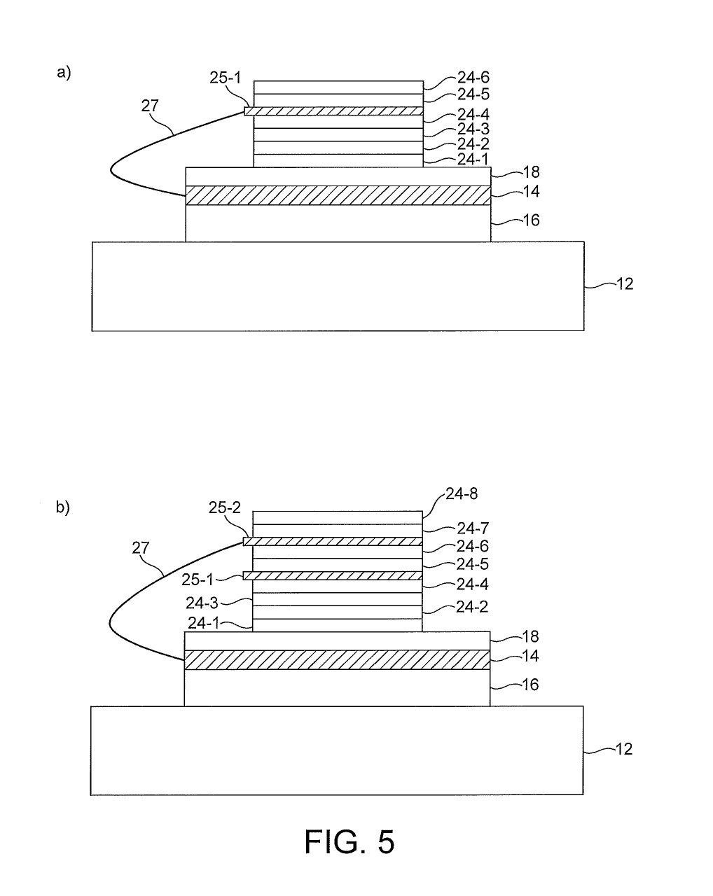

The technique is shown in FIG. 5a, whereby the base layer 12 comprises a conducting plate 14 between two insulating layers 16, 18 as before. In one embodiment, the conducting plate 14 is an aluminium plate at approximately −3000 VDC. As shown, the body of the build comprises a plurality of layers of non-conductive insulator material which represent a plurality of printed layers. Between a fourth and fifth layer of insulator material 24-4 and 24-5 is a first intermediate conductive plane 25-1. In one embodiment, the intermediate conductive plane 25-1 is a sheet or layer of aluminium foil that is electrically connected to the plate 14 through conductive region 27. As the build progresses, and when the field is unable to progress sufficiently through the plurality of printed or insulating layers, the intermediate conductive plane 25-1 being electrically coupled to the conducting plate 14 causes the field to propagate further through the successively applied print layers of insulating material.

In order to prevent sparking between layers, the conductive planes 25 are insulated from each other and ground. In addition, insulating the intermediate conductive planes prevent the intermediate planes from shielding or preventing the propagation of the field through the material. In effect, because the intermediate conductive planes/layers are insulated they are at floating potential which enables the field to propagate through the material.

As shown in FIG. 5b, further printed layers of insulating material 24 are added on top of the first intermediate conductive plane 25-1. A second intermediate conductive plane 25-2 is situated between sixth and seventh printed layers 24-6, 24-7. This second intermediate conductive plane 25-2 is also electrically coupled to the conducting plate 14 in order to further propagate the field through the layers as they are built up.

Causing the field to propagate in the above manner causes a sufficient field on the surface of the printed material such that new layers are sufficiently attracted to the surface to enable further print layers to be added.

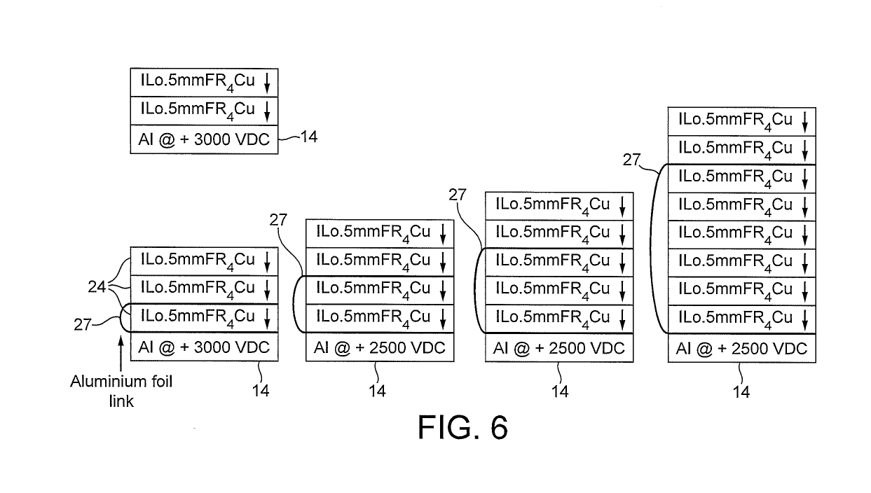

FIG. 6 shows details of an experiment carried out in relation to the transfer step at station C and using the leap-frogging technique described above. During this experiment, the conducting plate started at 3000 VDC but this was too high because it caused sparking so the voltage was reduced to 2500 VDC as shown.

In order to successfully use the leap-frogging to propagate the field through the printed body (also called the build stack), it is necessary to introduce intermediate conductive planes before the deposited layers reach a maximum printable thickness. This maximum thickness is determined by a user specified voltage limit and target field strength.

For example, when using a 3000V DC power supply the maximum thickness of toner through which the field can pass while maintaining a field strength of 1.5M V/m at the surface is about 2 mm. Therefore, the intermediate conductive plane is introduced before this thickness is reached. In the experiment, shown in FIG. 6, an intermediate conductive plane was inserted at the half-way point at about 1.0 mm.

This conductive plane can in introduced in many different ways. For example, of the intermediate conductive plane may be formed by 1) adding an aluminium or similar type foil to the build stack, 2) sputtering the upper surface of the build stack with a conductive material (e.g. gold), 3) spraying a conductive coating on the upper surface of the build stack, or 4) by printing a material which has sufficient conductivity.

As described above, the conductive plane is caused to remain at a floating potential so it does not shield the new toner from the field. Also the voltage is adjusted so as not to spark with the conductive plate or with other parts of the printing apparatus, i.e. a photoreceptor or transfer roller. In this way, the intermediate conductive plane is insulated so that the field, which is not yet being generated at the new conductive plane is able to pass through it from the charged base plate (or from any other intermediate conductive plane) and to fulfil its purpose during transfer and detack subsequently at station C.

As a precautionary measure to minimize the risk of sparking between the printing apparatus and conductive plane, several layers are printed before the intermediate conductive plane is connected to the voltage source.

In the case where the printing apparatus uses a final transfer roller which has an insulated coating it is possible to use fewer layers than the example above. The voltage source is connected to the intermediate conductive plane. Given the near proximity of the conductive plane to the printer apparatus the voltage is reduced to prevent sparking.

The accumulation of layers in the build stack is increased further until a new conductive plane is needed. In this way the connection to the high voltage power source is “leap frogged” up the print stack such that the field can propagate further through the build stack

Thus a field of constant strength can be established across the upper surface of the layer stack so that the toner particles are attracted to the surface and form a smooth homogenous surface. As the layers are built up, it is necessary to maintain the field strength at the surface remains the same. To ensure this is the case, the voltage applied to the base plate is controlled as the layers are built. For early layers, when the depth of the build is relatively small, the potential difference is kept small and as the layers increase the potential difference is increased such that the field strength remains constant on the surface throughout the build process.

One mechanism by which the field strength can be maintained at the surface is to set a target voltage for the surface. As the layers are built, the voltage on the surface can be measured and fed back in a feedback loop such that the voltage applied can be caused to increase to ensure that the applied electric field results in the surface voltage being maintained at the target voltage.

The potential difference is prevented from becoming too high so as to prevent sparking. Air at room temperature and humidity breaks down at 3M V/m (3×107 V·m-1) so this value is to be avoided. Typical field strengths at the transfer nip vary between 0.5M and 1.5M V/m.

A person skilled in the art will appreciate that there are other ways in which to maintain the voltage, for example, the voltage may be increased progressively as the thickness of the material increases. In addition, the voltage may be controlled manually so that it is progressively increased as the number of layers/thickness increases.

The aluminium foil layers 27 (intermediate conductive planes) should be configured so as not to shield the field from the charge plate. The experimental data shown in FIG. 6 demonstrates the ability to leapfrog from the base layer through several layers of insulating material and still maintain printing of a smooth surface on a top layer.

The leap-frogging technique described above involves the connection of the aluminium foil to the high voltage plate. However, it is also possible to transfer the field through the capacitive nature of the object as it is built. The capacitive nature is a by-product of alternating conductive layers and non-conductive layers. In the present example this is achieved by alternating the aluminium foil and ceramic plates without physically connecting them. When the base plate is charged, there is a potential difference between the base plate and the first layer of aluminium foil, which are separated by an insulating layer. This result in the aluminium layer(s) becoming inductively charged which enhances the homogeneity and strength of the field as it propagates through to the surface.

The intermediate conductive planes at floating potentials within an electric field will be charged inductively in a similar manner to parallel plate capacitors. By calculating the inductive charge on the conductive plates, the voltage supply can be adjusted so that the field can be propagated by these conductive planes without the need to physically connect them to the voltage supply.

Leap frogging with a wired connection to the high voltage supply can be used in combination with inductively charged conductive planes so as to maintain critical field strength and homogeneity.

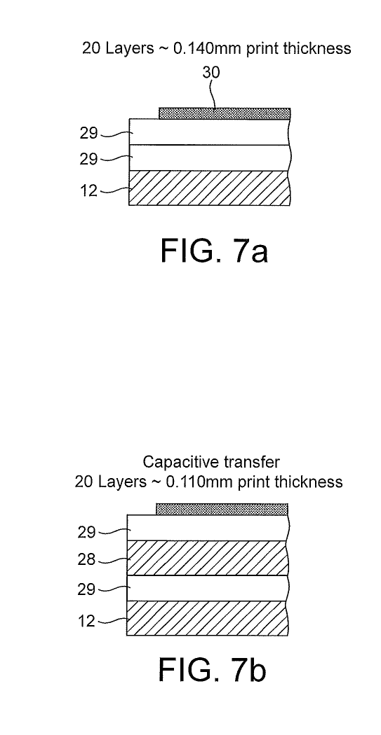

FIGS. 7a and 7b show a comparison between the transfer technique described with reference to FIG. 2 and the capacitive transfer technique.

In FIG. 7a, an aluminium base plate 12 is charged at +3000 volts DC with alternative layers of ceramic 29, and an extra ceramic substrate 30 on top of it before the substrate is printed on. Using this technique, it is possible to print 20 layers at approximately 0.140 mm print thickness.

FIG. 7b shows the result when an intermediate conductive layer 28 in the form of an aluminium foil between the ceramic layers 29. In this example, due to the capacitive transfer it is possible to print 20 layers at approximately 0.110 mm print thickness.

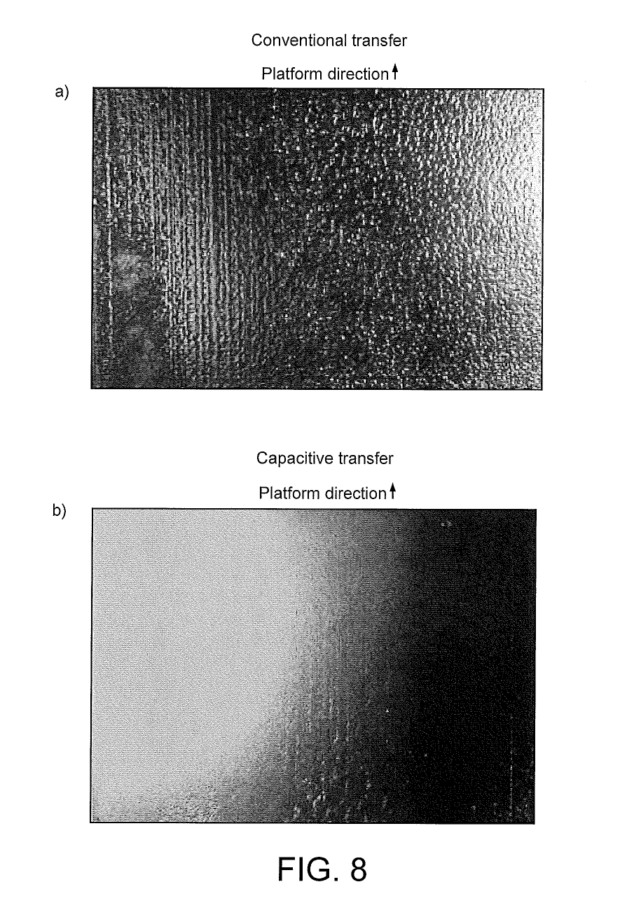

The results of the comparison between the conventional transfer and capacitive transfer of FIGS. 7a and 7b are shown in FIGS. 8a and 8b.

FIG. 8b shows that it is possible to print layer using this technique (i.e. without physically connecting the intermediate conductive layers to the base plate). This has been achieved purely through the inductive charging of the different plates causing the field to propagate through the surface of the build platform. The inventors have appreciated that such inductive charging is limited in terms of depth through the material and therefore this propagation of the field may not possible through out the whole object. However, this technique can be supplemented with the leap-frogging technique described above.

The depth to which the inductive charging technique may work is dependent upon field strength and the polarization which occurs in the printed material when it is in an electric field. Experimental data suggests evidence of field effects 5 mm away from the charged base conductive plate (where the stack from the bottom comprises: a 1 mm aluminium (Al) plate, which is charged to 3000 VDC; a 1 mm ceramic plate; a 1 mm Al plate; a 1 mm ceramic plate, a 1 mm Al plate, and a 1 mm ceramic plate, and one or more printed layers).

In some of the experiments carried out by the inventors, some cracking of the printed material was noticed. This is understood to be as a result of the brittleness of the printed material when using polyester toner, which is well-characterised and understood.

The inventors have appreciated that one way to overcome these problems is to print using a less brittle material. Alternatively, or in addition, another method involves cooling the printed object, to room temperature, in a controlled manner. The inventors have developed special printing materials which exhibit less brittleness.

Another solution lies in printing a larger number of thinner layers, which are less predisposed to cracking. In one embodiment several layers are printed in blocks and are assembled as blocks rather than directly printing layer upon layer upon layer throughout the entire thickness of the build stack.

Yet another solution is to use a fusing method which is not carried out at elevated temperatures as those described above. One such fusing method comprises spraying down a binder (i.e. an adhesive) in between each layer as an alternative to the heater fusing process described above. This provides us two advantages: firstly it is possible to use the materials which do not easily melt, for example ceramic and secondly it is possible to choose the conductivity of the binder so that it will form a conductive plane for conductive charging or leap-frogging as described above. Such a conductive binder layer can be used as a substitute to the conductive planes mentioned above. A further advantage is that the binder can also be used as an anti-static measure where we do not want to produce a volumetrically charged body.

A key advantage of using the additive building techniques described above, such as in a laser printing techniques, to print 3D objects is that it is possible to charge any substance so long as it is insulated. Therefore, any polymer, ceramic, or inorganic material may be used. It is possible to coat certain conductive materials in a non-conducting layer for the purposes of printing and thereafter removing the shell. In previous 3D printing techniques using inkjets, it has only been possible to use a single material per part. Complex items requiring multiple materials have to be prepared in different stages.

The key advantage of the present technique is that the materials can be mixed using laser printing techniques. Thus, successive layers of the stack can comprise different material compositions so that for example electronic parts and their housings can be made from different layer materials in one quick process.

In addition, it is a further advantage of using laser printing rather than inkjet printing, is that there is no liquid phase. Various materials for example water soluble polymers—which are used extensively in additive manufacturing as support material, sugar which is another desirable layer material because it is water soluble, are not able to be suspended in a liquid for use in ink jet printing. Therefore by removing the liquid phase it is possible to use these materials in a laser printing technique.

The described printing process has a further advantage over known dry printing techniques where it is known to cover a print area with dry powder and to selectively deposit binder in order to form layers in an additive manufacturing technique. In such existing techniques it is not possible to print using multiple materials in each layer. This is because there is no way of accurately controlling the placement of multiple powders. The present invention is advantageous because it is the placement of the materials themselves which is controlled in the transfer process, not just the placement of a binder.

A person skilled in the art will appreciate how the additive manufacturing techniques described herein can be used to manufacture 3D objects using materials. It is also be appreciated that this method ay also be used to manufacture 3D objects in blocks or smaller parts which are then assembled to form a whole object.

Other anti-static measures may be employed at the station B that involve managing the residual charge layer-by-layer as they are successively deposited. For example, the residual charge may be discharged by contacting the upper surface of the last deposited layer with a conductive grounded element prior to depositing the next layer.

Another approach is to spray or otherwise apply a conductive coating to the uppermost surface of the last deposited layer, which provides an electrically conductive path to the conductive layer 12. For example, a salt spray may be utilised which is subsequently evaporated before the next layer is deposited. Alternatively, the coating may comprise a polymer that also performs the fixing step for the deposited layer, with the advantage of avoiding the use of the separate fixing station A.

A further anti-static approach is to print down particles of opposite sign to those used to form the last layer so as to neutralise the residual charge. For example successive or successive groups of deposited layers may be formed of charged particles of opposite sign so as to cancel the residual charge.

Many other modifications and variations falling within the scope of the claimed invention will be evident to those skilled in the art. For example the steps shown in FIG. 1 need not necessarily be performed in the order shown in the Figure and other process sequences may be employed.

Also, further antistatic measures to achieve electrostatically favourable conditions for transfer or for achieving a target net charge on the consolidated body include: providing a dwell of sufficient time that the charge decays sufficiently not to impede the build process or end use of the consolidated body; using electromagnetic waves (gamma, microwave, etc.) or ionizing radiation (alpha, atoms, etc.); a moving or alternating magnetic field which induces movement of the charged particles; and phase change e.g evaporation, sublimation, of the deposited material or of an additional material such as water or IPA sprayed onto the layer.

Further modifications will be evident to those skilled in the art in the light of the foregoing description falling within the scope of the following claims.

1. An additive building method for building a plurality of layers to form a build stack, comprising:
providing a transfer medium with electrically charged particles to be deposited in successive overlying layers to provide the build stack,
depositing one of the layers of charged particles of the successive overlying layers onto a substrate to provide a first layer,
reducing a repulsive effect of residual charge of the first layer for a second of the layers subsequently deposited on the first layer, and
depositing the a second of the layers of charged particles from the transfer medium onto the first layer,
the reduction of the repulsive effect being performed such as to prevent an accumulation of residual charge resulting from the successively deposited layers and to provide homogeneous deposition of the layers.

2. A method according to claim 1 including applying an electric field to reduce the repulsive effect of residual charge on the deposited layers

3. A method according to claim 2 including adjusting the disposition of the field to maintain the reduction of the repulsive effect for the successively deposited layers.

4. A method according to claim 3 including adjusting the disposition of the field by applying an potential difference to create the electric field and increasing the potential difference in dependence the number and/or thickness of the layers deposited.

5. A method according to claim 3 including adjusting the disposition of the field by introducing a conductive layer between the first and second of said layers.

6. A method according to claim 1 wherein the repulsive effect is overcome by discharging the first of the layers prior to deposition of the second of the layers.

7. A method according to claim 6 including discharging the first of the layers by applying a conductive coating.

8. A method according to claim 7 wherein the conductive coating performs a layer fixing step.

9. A method according to claim 6 including discharging the first of the layers by applying a further layer of charged particles of opposite polarity to that of the residual charge.

10. A method according to claim 1 including directing ions from an ion source onto the first of the layers, the ions being of opposite polarity to that of the residual charge so as to reduce said repulsive effect.

11. An additive building method for building a plurality of layers to form a build stack, the method comprising:
creating a variable potential difference between a conducting element at a first voltage potential and an ion source at a second voltage potential;
creating an electric field between the conducting element and the ion source, wherein the field is caused to pass through the build stack to a nearest surface of the build stack which is nearest a transfer medium;
accumulating electric charge from the ion source on the nearest surface of the build stack; and
transferring deposition material from the transfer medium onto the nearest surface, wherein the strength of the field at the nearest surface of the build stack is controllable in order to effect a homogenous transfer of the deposition material on to the nearest surface.

12. The method of claim 11, further comprising varying the potential difference voltage between the conducting element and the ion source in order to increase the strength of the field at the nearest surface as the number of layers increases.

13. The method of claim 12, further comprising:
maintaining the conducting element at the first voltage potential; and
varying the second voltage potential of the ion source in order to vary the potential difference.

14. The method of claim 11, further comprising disconnecting the conducting element from the first voltage potential prior to the transferring step.

15. The method of claim 11 further comprising fusing the transferred deposition material to the free surface.

16. The method of claim 11 further comprising:
introducing an intermediate conducting plane as a layer in the build stack;
coupling the intermediate conducting plane to the conductive plate in order to increase the depth of penetration, through the build stack, of the field.

17. The method of claim 11, further comprising:
introducing an intermediate conducting plane as a layer in the build stack;
capacitively charging the intermediate conducting plane in order to increase the depth of propagation, through the build stack, of the electric field.

18. The method of claim 16, further comprising insulating the intermediate conducting plane.

19. The method of claim 16, further comprising depositing a plurality of intermediate conductive planes throughout the build stack;
capacitatively charging at least one of the plurality of intermediate conducting planes; and
coupling at least one of the plurality of intermediate conducting planes to the conductive element in order to increase the depth of penetration of the electric field.

20. The method of claim 11, further comprising using the ion source after the transferring step to discharge each of the layers as they are deposited in order to avoid volumetric charge trapping within the build stack.

21. The method of claim 1 including fusing the deposited layers by use of a heat source, a binding chemical agent, a temporary or permanent adhesive, ultrasonic consolidation, crosslinking and/or applied pressure.

22. (canceled)

23. An additive building system for building a plurality of layers to form a build stack, the system comprising:
a direct current (DC) voltage supply coupled to a conducting element arranged to place the conducting element at a first voltage potential;
an ion source, at a second voltage potential, for inducing an electric field between the conducting element and the ion source, and
a transfer device, wherein the electric field propagates through the build stack and causes an accumulation of electric charge on a nearest surface of the build stack which is nearest the transfer device, the transfer device being configured to transfer deposition material from a transfer medium onto the nearest surface, wherein the strength of the field at the free surface of the build stack is controllable in order to effect a homogenous transfer of the deposition material to the nearest surface.

24. The system of claim 23, further comprising a voltage controller for controlling the DC voltage applied to the conducting element to control a potential difference voltage between the conducting element and the ion source in order to increase the strength of the field at the nearest surface as the number of layers increases.

25. The system of claim 24, further comprising a voltage controller for controlling the DC voltage applied to the ion source to control a potential difference voltage between the conducting element and the ion source in order to increase the strength of the field at the nearest surface as the number of layers increases.

26. The system of claim 24, wherein the voltage controller is arranged to monitor the strength of the field at the free surface, and adjust the potential difference in order to maintain the field strength at a critical field strength.

27. The system of claim 23, wherein the conducting element is an insulated conductive plate supported on a build platform, the system further comprising:
a moving mechanism for moving the build platform between a charging station, transfer station and a fusing station, wherein the ion source is positioned at the charging station, the transfer device is positioned at the transfer station, and a fuser is positioned at the fusing station.

28. The system of claim 27, wherein the build platform is arranged to travel under the ion source at a controlled speed in order to effect the required accumulation of the electric charge on the nearest surface of the build stack.

29. (canceled)

30. (canceled)

31. The system of claim 23, including a fuser to fuse the transferred deposition material to the free surface, selected from: a heating source; a binding chemical agent; a temporary or permanent adhesive ultrasonic consolidation, crosslinking and/or applied pressure.

32. The system of claim 23, wherein at least one intermediate conductive plane is provided between successive layers in the build stack.

33. The system of claim 32, further comprising an electrical coupling between the at least one intermediate conductive plane and the conducting element.

34. The system of claim 23, wherein a plurality of intermediate conductive planes are provided at spaced apart locations through the build stack.

35-37. (canceled)

38. The method as claimed in claim 1 wherein the deposition material for the layers comprises one or more of the materials selected from the group comprising: a magnetic toner, a non-magnetic toner, polymer, ceramic, semi-conductive material, encapsulated conductive material, organic material, conductive material and inorganic material.

39. The method as claimed in claim 1 wherein the reducing of the repulsive effect of residual charge of the first layer for a second of the layers subsequently deposited on the first layer includes at least one of providing a dwell of sufficient time that the charge decays sufficiently not to impede the deposition of the second layer; using electromagnetic waves or ionizing radiation; using a moving or alternating magnetic field which induces movement of the charged particles; or phase change of the deposited material or of an additional material such as water or IPA sprayed onto the layer.
